(19) United States
(12) Patent Application Publication
(10) Pub. No.: US 2014/0311305 A1
(43) Pub. Date: Oct. 23, 2014

(54) Coin Roll Opener and Methods of Using The Same

(71) Applicant: Steven A. Richards, Malone, NY (US)

(72) Inventor: Steven A. Richards, Malone, NY (US)

(21) Appl. No.: 14/214,619

(22) Filed: Mar. 14, 2014

Related U.S. Application Data
(60) Provisional application No. 61/798,464, filed on Mar. 15, 2013.

(51) Int. Cl. G07G 1/00

(52) U.S. Cl. CPC G07G 1/0027
USPC 83/13; 83/698.11

(57) ABSTRACT

A coin-roll opener, e.g. a sleeve or the like for opening a roll of coins, and a method of using the same is described. The coin-roll opener comprises first and second sides with a transverse connector between them. Angles formed by joining the first and second sides of the coin-roll opener to the transverse connector form acute angles, or cutting edges of the transverse connector, abutting the transverse connector. The coin-roll opener is used by fitting it over at least one divider of a cash till or coin tray of a cash register. The coin-roll opener is used by striking a roll of coins against one of the acute angles, or cutting edges of the coin-roll opener, freeing the coins so that they can be deposited within the cash till or coin tray.

### 1.1 FIELD OF THE INVENTION

The present invention relates generally to accessories for the cash till or coin tray of a cash register, and more specifically to a device for safely, easily, and efficiently opening coin wrappers prior to transferring coins from the coin wrapper to the cash till or coin tray of a cash register without using a cutting blade or damaging the cash till or coin tray of the cash register.

### BACKGROUND

There is a need for easy, efficient openers for coin rolls, and methods of using the same.

One objective of the present invention is to provide a coin-roll opener such as a sleeve or the like to safely, easily, and efficiently open coin wrappers prior to transferring coins from the coin-roll to the cash till or coin tray of a cash register without using a cutting blade or damaging the cash till or coin tray of the cash register.

A second objective is to open rolls of coins without compromising the integrity of the cash till or coin tray.

A third objective is to use the frictional force of the coin-roll opener, to hold the coin-roll opener in place.

A fourth objective is to have the coin-roll opener remain on the cash till or coin tray and be functional at all times.

### SUMMARY OF THE INVENTION

A first aspect of the present invention provides a coin-roll opener, e.g. a sleeve or the like, for opening a roll of coins, where the coin-roll opener is adapted for operable coupling to a divider of a cash till or coin tray. The cash till or coin tray comprises first and second sides and a transverse connector between them. The divider extends through a gap between distal edges of the first and second sides of the coin-roll opener. A width of the transverse connector is wider than a width of the gap between proximal edges of the first and second sides of the coin-roll opener, and the transverse connector lies in a transverse plane between the proximal edges of the first and second sides of the coin roll opener.

A second aspect of the present invention provides a kit for depositing a roll of coins into a cash till or coin tray. The kit comprises a cash register having a cash till or coin tray, where the cash till or coin tray comprises dividers that form compartments into which coins are deposited, a coin-roll opener, e.g. a sleeve or the like, where the coin-roll opener fits over at least one divider in the cash till or coin tray of the cash register, where a top surface of the transverse connector of the coin-roll opener lies in a plane parallel to the transverse plane between the proximal edges of the first and second sides of the coin-roll opener, and where the transverse plane does not have an arcuate shape.

A third aspect of the present invention provides a method for opening a roll of coins in a coin wrapper and depositing the coins into a cash register. The method comprises providing a cash register having a cash till or coin tray, where the cash till or coin tray comprises dividers that form compartments into which coins are deposited, providing a coin-roll opener, e.g. a sleeve or the like, and fitting the coin-roll opener over at least one divider in the cash till or coin tray of the cash register, where a top surface of the transverse connector of the coin-roll opener lies in a plane parallel to the transverse plane between the proximal edges of the first and second sides of the coin-roll opener, and where the transverse plane does not have an arcuate shape.

### BRIEF DESCRIPTION OF THE FIGURES

The features of the invention are set forth in the appended claims. The invention itself, however, will be best understood by reference to the following detailed description of an illustrative embodiment when read in conjunction with the accompanying drawings, wherein:

FIG. 1 depicts a front elevation view of a cash register having a cash till or coin tray in a drawer, in which a divider of the cash till or coin tray is equipped with a coin-roll opener, e.g. a sleeve or the like, in accordance with embodiments of the present invention;

FIG. 2 depicts an exploded view of a portion of the cash till or coin tray in FIG. 1, in accordance with embodiments of the present invention;

FIG. 3 depicts a front cross-sectional view of cash till or coin tray depicted in FIGS. 1 and 2, in accordance with embodiments of the present invention;

FIG. 4 depicts a side elevation view of the cash register depicted in FIG. 1, in which the drawer is closed, in accordance with embodiments of the present invention;

FIG. 5a depicts an a side elevation view of the coin-roll opener shown in FIGS. 2 and 3, further comprising nibs at the edge of the first and second sides, in accordance with embodiments of the present invention;

FIG. 5b depicts the coin-roll opener shown in FIG. 5a after rotating 180 degrees in plane and 90 degrees out of plane, in accordance with embodiments of the present invention;

FIG. 6 depicts a longitudinal cross-sectional view of the coin-roll opener after being operably coupled to the divider of the cash till or coin tray, with rounded corners, in accordance with embodiments of the present invention;

FIG. 7 depicts a method for opening a roll of coins in a coin wrapper and depositing the coins into a cash till or coin tray, in accordance with embodiments of the present invention; and

FIG. 8 depicts coins in the cash till or coin tray after completing the method depicted in FIG. 7, in accordance with embodiments of the present invention.

### DETAILED DESCRIPTION OF THE EMBODIMENTS OF THE INVENTION

### Definitions

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

It must be noted that as used herein and in the appended claims, the singular forms “a,” “and,” and “the” include plural references unless the context clearly dictates otherwise.

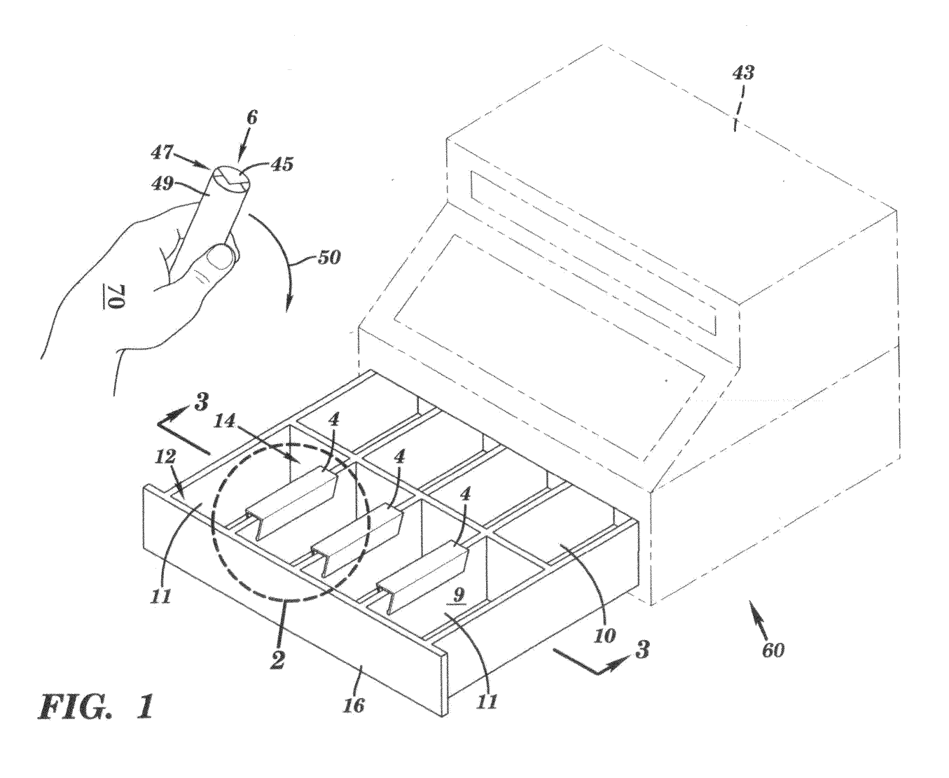

Referring to FIGS. 1, 3, 4 and 5 as used herein, unless otherwise defined, the terms “distal edges 23, 21” and “proximal edges 31, 29” refer to proximity of distal edges 23, 21 of the first and second sides 13, 15, respectively, to the transverse connector 17, and the proximity of proximal edges 31, 29 of the first and second sides 13, 15, respectively to the transverse connector 17, where the proximal edges 31, 29 are the edges closer to the transverse connector 17 and the distal edges 23, 21 are the edges further from the transverse connector 17. Therefore, the proximal edge 31 of the first side 13 is the edge on the first side 13 closer to the transverse connector 17. The distal edge 23 of the first side 13 is the edge on the first side 13 further than edge 31 from the transverse connector 17.

As used herein, unless otherwise defined, the term “coin-roll wrapper” refers to a paper or plastic sleeve, encompassing a coin-roll, to contain a roll of coins and maintain the typically cylindrical shape of a coin-roll.

As used herein, unless otherwise defined, the term “coin-roll” refers to a roll of metallic coins used as monetary currency.

As used herein, unless otherwise defined, the term “operably coupled” when referring to the coin-roll opener 4, e.g. a sleeve or the like being removed from or applied to the lateral bin dividers 9, means releasably joining, coupling, or attaching by physical or mechanical means by inserting the top edge 59 of the lateral bin dividers 9 into the gap 19 of the coin-roll opener 4.

As used herein, unless otherwise defined, the term “acute angle” when referring to the angles 35, 33, means angles at the junctions of the first and second sides 13, 15 of the coin-roll opener 4 and the transverse connector 17 being less than 90°.

As used herein, unless otherwise defined, the term “not arcuate” when referring to the transverse connector 17 means not having the form of a bow shape; e.g., curved shape.

FIG. 1 depicts a front elevation view of a frame 43 of a cash register 60 having a cash till or coin tray 12 in a drawer 16, in which a divider 9 of the cash till or coin tray 12 is equipped with a coin-roll opener 4, e.g. a sleeve or the like.

The coin-roll opener 4 may be made from glass filled nylon, metal, or plastic. The coin-roll opener 4, e.g. a coin-roll opener or the like, may be made from any material which enables the coin-roll opener 4 to return to its original shape after the stress that caused its deformation is no longer applied.

The coin-roll opener 4, e.g. a sleeve or the like is used for opening the coin wrapper 49 of the roll of coins 6 so that the operator does not have to open a folded end 47 of the package via a closing flap 45, which is vastly inefficient. Instead, the coin-roll opener 4 is used in a downward striking motion 50, striking the coin wrapper 49 against the coin-roll opener 4, and then allowing the coins 1 to drop into their assigned bin.

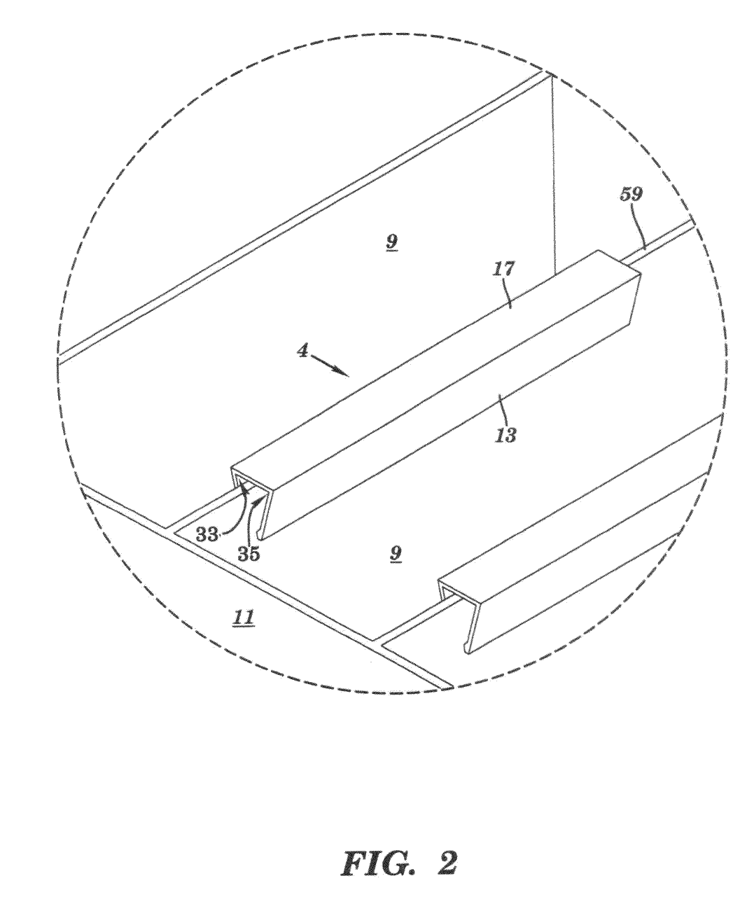

FIG. 2 depicts an exploded view of a portion of the cash till or coin tray 12 in FIG. 1.

In an embodiment an angle 33 between the first side 13 and the transverse connector 17 forms an acute angle, e.g. an angle 35 between the second side 15 and the transverse connector 17. The angles 35, 33 function as cutting edges of the transverse connector 17. The sides of the coin-roll opener 4, e.g. a sleeve or the like are joined to the transverse connector 17 at an acute angle 35, 33, granting an easy “cutting edge”. This edge allows for the rapid, directed application of force to the coin-roll 6, allowing it to be easily opened.

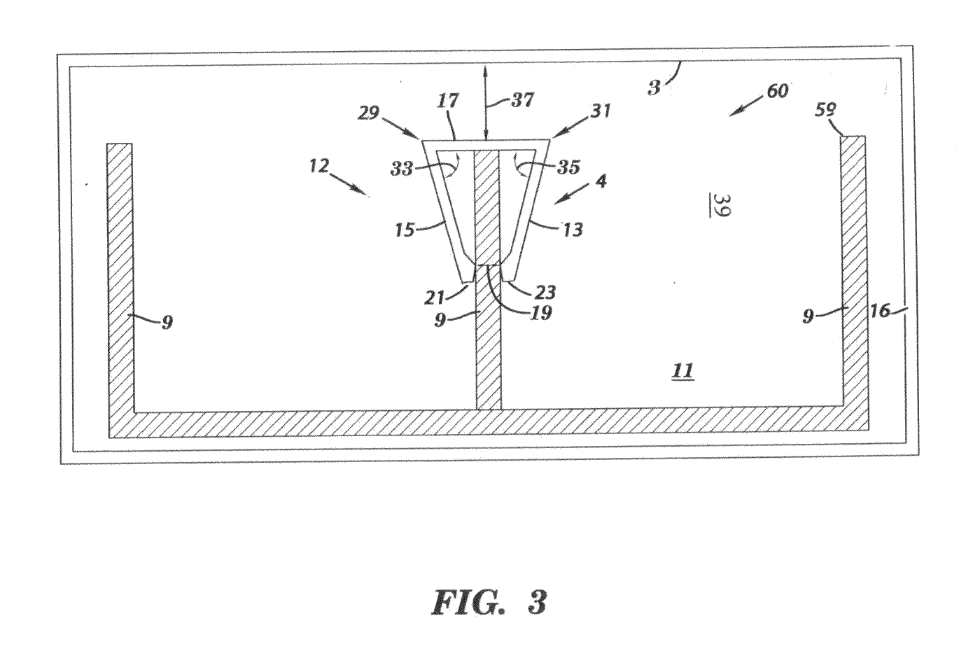

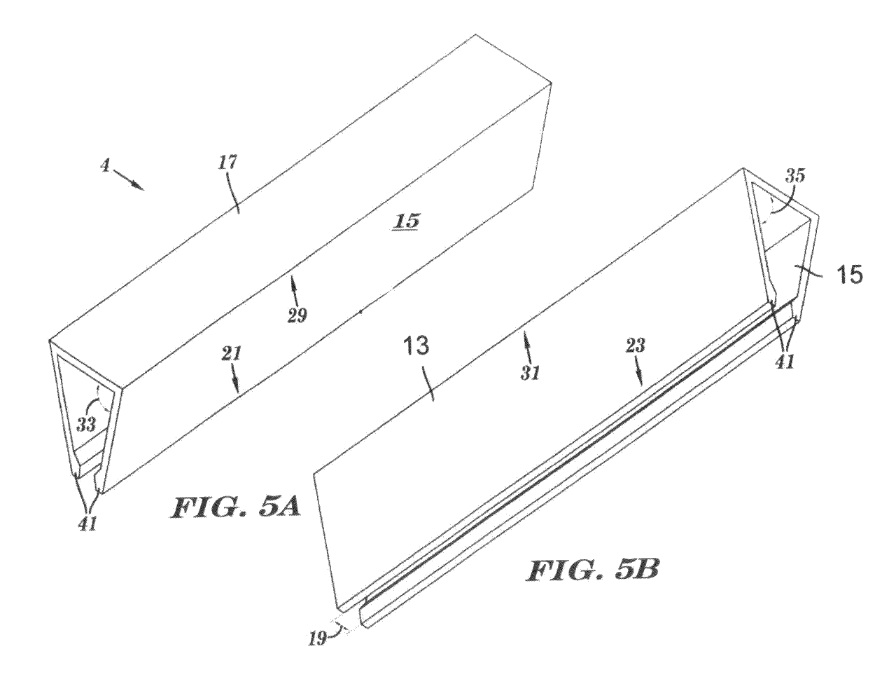

In an embodiment the width of the transverse connector 17 between the distal edges 23, 21 of the first side 13 and second side 15 is wider than a width of gap 19, so that the coin-roll opener 4, e.g. a sleeve or the like, operably couples to the divider 9 using frictional force between the distal edges 23, 21 of the first side 13 and the second side 15, not grippers. The gap 19 is narrower when the coin-roll opener 4 is not operably coupled to the divider 9, as shown in FIG. 5b, than it is when the coin-roll opener 4 is operably coupled to the divider 9, as shown in FIG. 3.

In an embodiment the coin-roll opener 4 is adapted for operably coupling to a divider 9 of a cash till or coin tray 12. The coin-roll opener 4 first within the opening 39 within the confines of the inside of the drawer 16 when it operably couples to the divider 9, so the coin-roll opener 4 does not have to be detached from the divider 9 when the drawer is opened or closed.

In an embodiment the distal corners 52 of the first and second sides 13, 15 may be rounded.

FIG. 3 depicts a front cross-sectional view of cash till or coin tray 12 depicted in FIG. 1, taken along the line 3-3, as depicted in FIG. 1. The coin-roll opener 4 comprises first and second sides 13, 15 with a transverse connector 17 between them. The divider 9 of the cash till or coin tray 12 extends through a gap 19 between distal edges 23, 21 of the first and second sides 13, 15 of the coin-roll opener 4. A width of the transverse connector 17 between distal edges 23, 21 of the first and second sides 13, 15 of the coin-roll opener 4 is wider than the gap 19, so the coin-roll opener 4 operably couples to the divider 9 using frictional force to grip the divider 9, not grippers. The transverse connector 17 lies in the transverse plane between distal edges 23, 21 of the first and second sides 13, 15 of the coin-roll opener 4. Angles 35, 33 formed by joining the first and second sides 13, 15 of the coin-roll opener 4 to the transverse connector 17 may form acute angles, or cutting edges of the transverse connector 17, abutting the transverse connector 17. Corners 52 of the first and second sides 13, 15 of the coin-roll opener 4 may be rounded. The coin-roll opener 4 fits within an opening 39 within the confines of the inside of the drawer 16 when the coin-roll opener 4 is operably coupled to the divider 9, so that the coin-roll opener 4 does not have to be detached from the divider 9 when the drawer 16 is opened or closed.

One objective of the invention is to open rolls of coins 6 without compromising the integrity of the cash till or the coin tray 12. The coin-roll opener 4 does this by providing proximal edges 31, 29 of first and second sides 13, 15, e.g., a cutting edge, of the transverse connector 17 of the coin-roll opener 4 that are not integral to the cash till or coin tray 12. This allows for rolls of coins 6 in coin wrapper 49 to be opened without directly hitting (and thus damaging) the cash till or coin tray 12.

Referring to FIG. 1, the coin-roll opener 4, e.g. a sleeve or the like, for opening the roll of coins 6 in the coin wrapper 49 is depicted while in operation in a drawer 16 in the frame 43 of the cash register 60. The drawer 16 is divided into front and rear compartments 10, 11 which are separated by a transverse divider 14. Each compartment, in turn, is separated by a compartmental divider 9. The coin-roll opener 4 is adapted for operable coupling to the divider 9 of the cash till or coin tray 12.

Referring to FIG. 3, first and second sides 13, 15 of coin-roll opener 4 have a transverse connector 17 between them. The divider 9 extends through a gap 19 between proximal edges 23, 21 of the first and second sides 13, 15 of the coin-roll opener 4. A width of the transverse connector 17 between proximal edges 31, 29 of the first and second sides 13, 15 is wider than the gap 19 between distal edges 23, 21 of the first and second sides 13, 15 of the coin-roll opener 4. The transverse connector 17 lies in a plane that is parallel to the plane defined by the top of the divider 9. A gap represented by the bidirectional arrow 37 may be left between the top surface 51 of the transverse connector 17 of the coin roll opener 4 and an upper surface 3 of the drawer 16 of the frame 43 of the cash register 60, depicted in FIG. 3, and described herein. Therefore, the coin-roll opener 4 may fit in an opening 39 within the confines of the inside of the drawer 16 when the coin-roll opener 4 is operably coupled to the divider 9, so the coin-roll opener 4 does not have to be detached from the divider 9 when the drawer 16 is removed or replaced in the frame 43 of the cash register 60, e.g., when the drawer 16 is opened or closed.

The coin-roll opener 4, e.g. a sleeve or the like, fits within the opening 39 within the confines of the inside of the drawer 16 when the coin-roll opener 4 releasably couples to the divider 9, so that the coin-roll opener 4 does not have to be detached from the divider 9 when the drawer 16 is opened or closed. Hereinafter, unless otherwise defined, the term “opened” or “closed” when referring to the drawer 16 means the drawer 16 has been removed from or inserted into the opening within the frame 43 of the cash register 60, so that the coin-roll opener 4 does not have to be detached from the divider 9 when the drawer 16 is opened or closed.

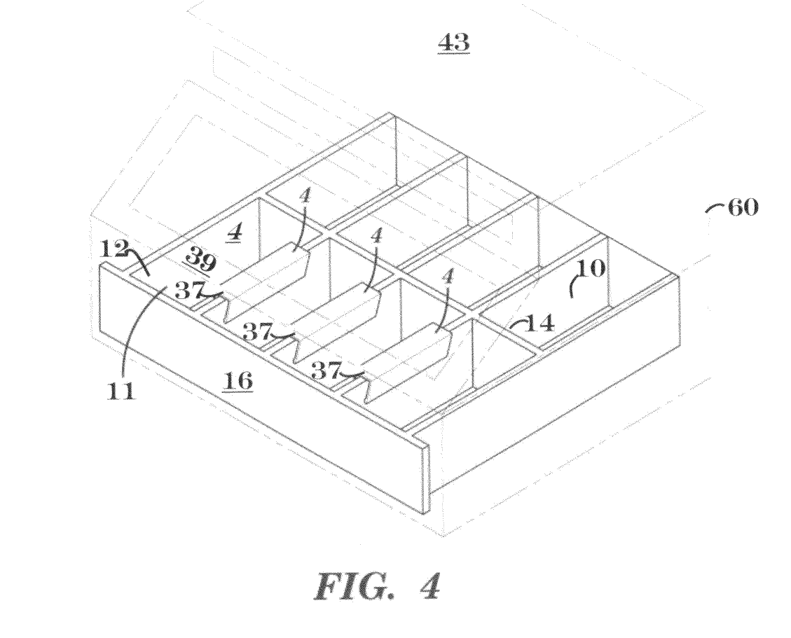

FIG. 4 depicts a side elevation view of the frame 43 of the cash register 60 depicted in FIG. 1, in which the drawer 16 is closed. Hereinafter, unless otherwise defined, the term “closed” when referring to the drawer 16 means the drawer 16 has been inserted into the opening of the frame 43 of the cash register 60, resulting in a user 70 having no access to the cash till or coin tray 12 when the drawer 16 is closed.

In an embodiment, the coin-roll opener 4, e.g. a sleeve or the like, fits in the opening within the confines of the frame 43 of the cash register 60 when it operably couples to the divider 9, so that the coin-roll opener 4 does not have to be detached from the divider 9 when the drawer 16 is opened or closed, enabling the objective allowing the coin-roll opener 4 to remain on the cash till or coin tray 12 even when the drawer 16 in the frame 43 of the cash register 60 is closed. This is done by having the transverse connector 17 of the coin-roll opener 4 lie below a plane defined by the upper surface 3 of the drawer 16 of the frame 43 of the cash register 60, depicted in FIG. 3, and described herein, when the coin-roll opener 4 is operably coupled to the divider 9. In one embodiment the bidirectional arrow 37 designates a gap that the transverse connector 17 may lie below the plane of the upper surface 3 of the drawer 16 of the frame 43 of the cash register 60, depicted in FIG. 3, and described herein. This allows the drawer 16 to fully open and close without interference from the coin-roll opener 4 from its operably coupled position on the divider 9 of the cash till or coin tray 12, thus enabling the objective allowing the coin-roll opener 4 to remain installed on the divider 9 during the drawer 16 opening and closing operations.

FIG. 5a depicts a side elevation view of the coin-roll opener 4, e.g. a sleeve or the like, shown in FIGS. 2-3, further comprising nibs 41 at the distal edges 23, 21 of the first and second sides 13, 15.

A third objective is to use the frictional force of the coin-roll opener 4 to hold the coin-roll opener 4 in place on the divider 9. The coin-roll opener 4 may be made from glass filled nylon, metal, or plastic. A width of the gap 19 between the distal edges 23, 21 of the first and second sides 13, 15 of the coin-roll opener 4 is less than the width of the divider 9. When the coin-roll opener 4 is inserted over the top 59 of the divider 9, the resistance of the material out of which the coin-roll opener 4 is made to expand the width of the gap 19 creates a frictional force along the inner surfaces of the sides 13, 15 of the coin-roll opener 4, holding the coin-roll opener 4 in place. This eliminates the need for any stoppers or grippers to hold the coin-roll opener 4 in place.

In an embodiment, the first and second sides 13, 15 may terminate in nibs 41, i.e., protuberances at the edge of the first and second sides 13, 15. The coefficient of friction has been increased through texturing, increasing the strength of the frictional forces holding the coin-roll opener 4 in place. This allows the coin-roll opener 4 to releasably couple more securely.

FIG. 5b depicts the coin-roll opener 4 shown in FIG. 5a after rotating 180 degrees in plane and 90 degrees out of plane. The gap 19 is narrower when the coin-roll opener 4 is not operably coupled to the divider 9, as shown in FIG. 5b, than it is when the coin-roll opener 4 is operably coupled to the divider 9, as shown in FIG. 3.

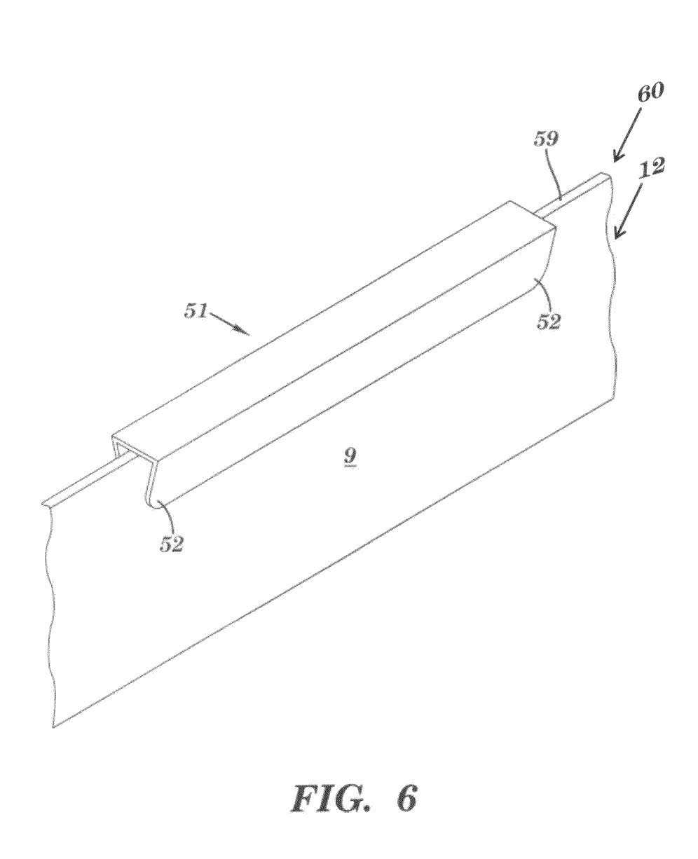

FIG. 6 depicts a longitudinal cross-sectional view of the coin-roll opener 4, after being operably coupled to the divider 9 of the cash till or coin tray 12.

In an embodiment, the distal corners 52 of the coin-roll opener 4, e.g. a sleeve or the like, may be rounded because it is less costly to make the distal corners 52 rounded, and because the coin roll opener 4 may more easily slide over the divider 9 if the distal corners 52 are rounded.

In one embodiment, FIGS. 1-6 depict a kit for depositing coins 1 from a roll of coins 6 in a coin wrapper 49 into a cash till or coin tray 12 comprising a cash register 60 having a cash till or coin tray 12, where the cash till or coin tray 12 has dividers 9 between which coins 1 from the roll of coins 6 may be deposited, a coin-roll opener 4, e.g. a sleeve or the like, where the coin-roll opener 4 fits over at least one divider 9 in the cash till or coin tray 12 of the cash register 60, a top surface 51 of the coin-roll opener 17 lies in a plane parallel to a longitudinal axis of the divider 9, and where the transverse connector 17 does not have an arcuate shape. The distal corners 52 of first and second sides 13, 15 of the coin-roll opener 4 may be rounded. The angles 35, 33 formed by joining the first and second sides 13, 15 of the coin-roll opener 4 to the transverse connector 17 may form acute angles 35, 33, functioning as cutting edges of the transverse connector 17. The width of the gap 19 between distal edges 23, 21 of the first and second sides 13, 15 of the coin-roll opener 4 may be less than a width of the divider 9, so that the coin-roll opener 4 operably couples to the divider 9 using frictional force to grip the divider 9, not grippers. A gap represented by the bidirectional arrow 37 may be left between the top surface 51 of the transverse connector 17 of the coin roll opener 4 and an upper surface 3 of the drawer 16 of the frame 43 of the cash register 60, depicted in FIG. 3, and described herein. Therefore, the coin-roll opener 4 may fit within an opening 39 within the confines of the inside of the frame 43 of the cash register 60 when the coin-roll opener 4 is operably coupled to the divider 9, so the coin-roll opener 4 does not have to be detached from the divider 9 when the drawer 16 is removed or replaced in the frame 43 of the cash register 60, e.g., when the drawer 16 is opened or closed. The coin-roll opener 4 may be made from glass filled nylon, metal, or plastic. The first and second sides 13, 15 of the coin-roll opener 4 may terminate in protuberances 41 which increase the coefficient of friction through texturing, in turn increasing the strength of the frictional forces holding the coin-roll opener 4 in place.

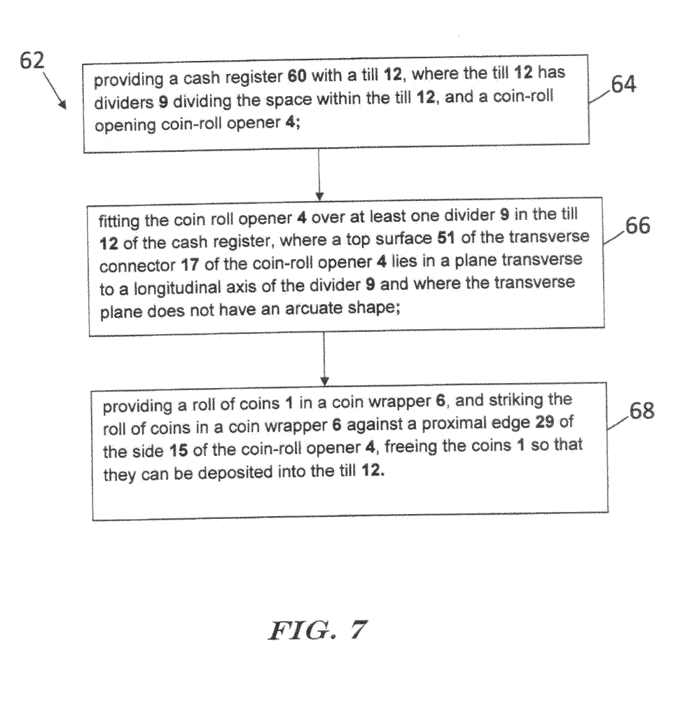

FIG. 7 depicts a method 62 for opening a roll of coins 6 in a coin wrapper 64 and depositing the coins 1 into a cash till or coin tray 12 comprises: a step 64: providing a cash register 60 with a cash till or coin tray 12, where the cash till or coin tray 12 has dividers 9 dividing the space within the cash till or coin tray 12, and a coin-roll opening coin-roll opener 4. In a step 66, the coin-roll opener 4 is then fitted over at least one divider 9 in the cash till or coin tray 12 of the cash register 60, where a top surface 51 of the transverse connector 17 of the coin-roll opener 4 lies in a plane transverse to a longitudinal axis of the divider 9 and where the transverse plane does not have an arcuate shape. In a step 68: A roll of coins 6 in a coin wrapper 49 may be provided, after which the roll of coins 6 in a coin wrapper 49 may be struck against the proximal edge 29 of the side 15 of the coin-roll opener 4, or alternatively against the proximal edge 31 of the side 13 of the coin-roll opener 4, freeing the coins 1 so that they can be deposited into the cash till or coin tray 12. The coin-roll opener 4 may be releasably coupled to the till divider 9, so that the coin-roll opener 4 can be removed from one divider 9 and place upon another at need. The coin-roll opener 4 may be retractable into the inside of the cash register drawer 16 along with the cash till or coin tray 12 to which it is coupled, as the top surface 51 of the transverse connector 17 of the coin-roll opener 4 might not contact the inside of the cash register drawer 16 in an embodiment.

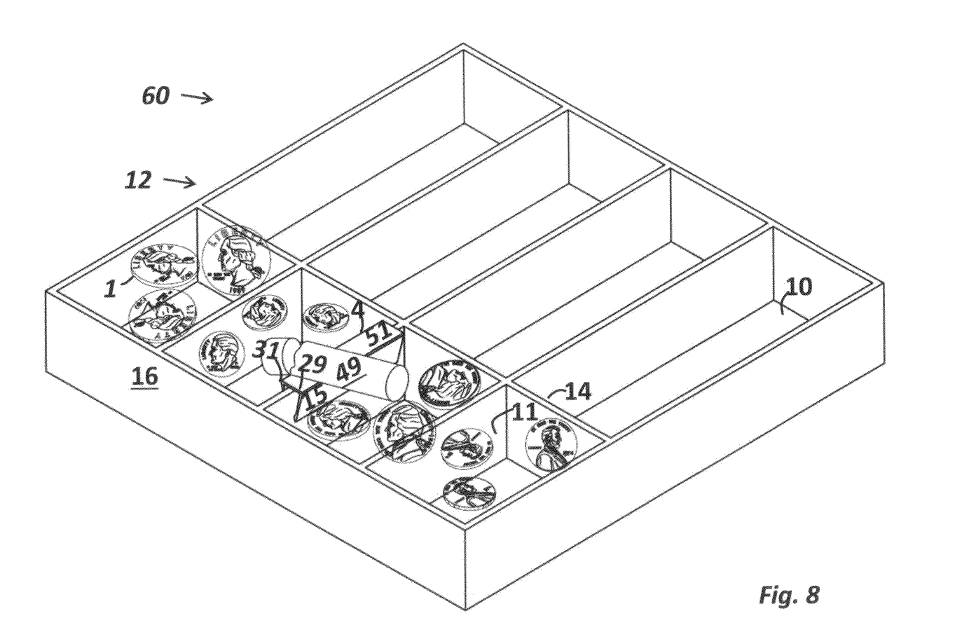

FIG. 8 depicts coins 1 in the cash till or coin tray 12 after completing the method 62 depicted in FIG. 7.

While exemplary embodiments have been specifically disclosed, it should be understood that the practice of this invention is not limited to those embodiments. Modifications and variations falling within the spirit of the invention will occur to those skilled in the art. Therefore, it is not intended that the scope of the invention be determined by the disclosed exemplary embodiments, but rather should be determined by the breadth of the appended claims.

I claim:

1. A coin-roll opener, for opening a roll of coins, wherein the coin-roll opener is adapted for operable coupling to a divider of a cash till or coin tray, comprising:
first and second sides and a transverse connector therebetween;
wherein the divider extends through a gap between distal edges of the first and second sides of the coin-roll opener,
wherein a width of the transverse connector is wider than a width of the gap between distal edges of the first and second sides of the coin-roll opener, and
wherein the transverse connector lies in a transverse plane between proximal edges of the first and second sides of the coin-roll opener.

2. The coin-roll opener of claim 1, wherein distal corners of the first and second sides of the coin-roll opener are rounded.

3. The coin-roll opener of claim 1, wherein angles formed by joining the first and second sides of the coin-roll opener to the transverse connector form acute angles.

4. The coin-roll opener of claim 1, wherein the angles function as cutting edges of the transverse connector.

5. The coin-roll opener of claim 1, wherein the width of the gap between ends of the first and second sides of the coin-roll opener is less than a width of the divider, so the coin-roll opener operably couples to the divider using frictional force to grip the divider, not grippers.

6. The coin-roll opener of claim 1, wherein the coin-roll opener fits within the opening within the confines of the inside of the drawer when it operably couples to the divider, so the coin-roll opener does not have to be detached from the divider when the drawer is opened or closed.

7. The coin-roll opener of claim 1, wherein the coin-roll opener is made from glass filled nylon, metal or plastic.

8. The apparatus of claim 1, wherein the first and second sides of the apparatus terminate in nibs, comprising:
protuberances at the edge of the first and second sides
wherein the coefficient of friction has been increased through texturing increasing the strength of the frictional forces holding the coin-roll opener in place.

9. A kit for depositing a roll of coins into a cash register, cash till or coin tray, comprising:
a cash register having a till, wherein the till comprises dividers that form compartments into which coins are deposited;
a coin-roll opener,
wherein the coin-roll opener fits over at least one divider in the cash till or coin tray of the cash register,
wherein a transverse connector lies in a transverse plane between proximal edges of the first and second sides of the coin-roll opener, and
wherein the transverse plane does not have an arcuate shape.

10. The coin-roll opener of claim 9, wherein distal edges of the first and second sides of the coin-roll opener are rounded.

11. The coin-roll opener of claim 9, wherein angles formed by joining the first and second sides of the coin-roll opener to the transverse connector form acute angles.

12. The coin-roll opener of claim 9, wherein the angles function as cutting edges of the transverse connector.

13. The coin-roll opener of claim 9, wherein the width of the gap between ends of the first and second sides of the coin-roll opener is less than a width of the divider, so the coin-roll opener operably couples to the divider using frictional force to grip the divider, not grippers.

14. The coin-roll opener of claim 9, wherein the coin-roll opener fits within the confines of the inside of the drawer when it operably couples to the divider, so the coin-roll opener does not have to be detached from the divider when the drawer is opened or closed.

15. The coin-roll opener of claim 9, wherein the coin-roll opener is made from glass filled nylon, metal or plastic.

16. The apparatus of claim 1, wherein the first and second sides of the apparatus terminate in nibs, comprising:
protuberances at the edge of the first and second sides
wherein the coefficient of friction has been increased through texturing increasing the strength of the frictional forces holding the coin-roll opener in place.

17. A method for opening a roll of coins in a coin wrapper and depositing the coins into a cash register, comprising:
providing a cash register having a cash till or coin tray, wherein the cash till or coin tray comprises dividers that form compartments into which coins are deposited;
providing a coin-roll opener; and
fitting the coin-roll opener over at least one divider in the cash till or coin tray of the cash register,
wherein a top surface of the transverse connector of the coin-roll opener lies in a plane parallel to a transverse plane between proximal edges of the first and second sides of the coin-roll opener, and
wherein the transverse plane does not have an arcuate shape.

18. The method of claim 17, comprising:
providing a roll of coins in a coin wrapper.

19. The method of claim 18, comprising:
striking the roll of coins in the coin wrapper against a proximal edge of the coin-roll opener; and
freeing the coins so they can be deposited into the cash till or coin tray.

20. The method of claim 17, comprising:
releasably coupling the coin-roll opener to the till divider;
removing the coin-roll opener from one divider to which it is coupled; and
releasably coupling the coin-roll opener to another divider.

21. The method of claim 10, comprising:
retracting the till or coin tray into an opening of the frame of the cash register,
wherein the top surface of the a transverse connector of the coin-roll opener does not interfere with retracting the cash till or coin tray and the drawer of the cash register into an opening in the frame of the cash register because the top surface of the transverse connector of the coin-roll opener does not contact an inner surface of the frame of the cash register drawer.
